(19) United States
(12) Patent Application Publication
(10) Pub. No.: US 2013/0106704 A1
(43) Pub. Date: May 2, 2013

(54) LAPTOP COMPUTER

(71) Applicants: YAEL VIDAL, New York, NY (US); Joel Vidal, New York, NY (US)

(72) Inventors: YAEL VIDAL, New York, NY (US); Joel Vidal, New York, NY (US)

(21) Appl. No.: 13/281,568

(22) Filed: Oct. 26, 2011

(51) Int. Cl. G06F 3/02

(52) U.S. Cl. 345/169; 345/172

(57) ABSTRACT

Disclosed is a laptop computer having a physical keyboard, as well as a physical button or mechanical switch to selectively disable and enable only the physical keyboard of the laptop computer. The physical button or mechanical switch allows the user to toggle the laptop computer between two or more operational modes: a first operational mode, in which the screen of the laptop is enabled and the physical keyboard of the laptop is enabled; and a second operational mode, in which the screen of the laptop is enabled but the physical keyboard of the laptop is disabled.

### FIELD

Some embodiments are related to the field of laptop computers.

### BACKGROUND

A laptop computer, also known as a laptop or a notebook computer or a notebook, is a personal computer which may be portable and may allow a user to perform mobile computing activities. Such activities may include, for example, word processing, Internet browsing, sending and receiving electronic mail (email), playing games, or the like.

### SUMMARY

Some embodiments may include, for example, a laptop computer having a button able to selectively and particularly enable and disable the physical keyboard of the laptop computer, without interrupting or disabling the operation of the screen (or other components) of the laptop computer.

In some embodiments, a laptop computer may include a physical keyboard, as well as a physical button or mechanical switch to disable and enable the physical keyboard of the laptop computer. The physical button or mechanical switch allows the user to toggle the laptop computer between two or more operational modes: a first operational mode, in which the screen of the laptop is enabled and the physical keyboard of the laptop is enabled; and a second operational mode, in which the screen of the laptop is enabled but the physical keyboard of the laptop is disabled.

In some embodiments, for example, a laptop computer may include: a screen unit to display text and graphics; a physical keyboard unit comprising a plurality of physically-pressable keys to receive user keypresses, wherein the physical keyboard unit and the screen units are two distinct hardware units; and a physical button to toggle between a first operational mode and a second operational mode; wherein in the first operational mode the physical keyboard unit is enabled and the screen unit is enabled, and in the second operational mode the physical keyboard unit is disabled and the screen is enabled.

In some embodiments, for example, the physical keyboard unit is part of a base unit of the laptop, and wherein the base unit is mechanically connected to the screen unit via one or more hinges.

In some embodiments, for example, the screen unit is able to rotate via a single angle of rotation relative to the physical keyboard unit.

In some embodiments, for example, the screen unit and the physical keyboard unit comprise two respective and interconnected parts of a shell-like laptop structure.

In some embodiments, for example, the physical keyboard unit comprises a plurality of physical keys; wherein each one of the physical keys, upon being pressed down, is to decrease its position by at least two millimeters below a non-pressed position; wherein, when the physical button indicates the second operational mode, in which the physical keyboard unit is disabled and the screen is enabled, the laptop computer is not operationally responsive to pressing down of said physical keys.

In some embodiments, for example, each one of said physical keys, upon being released subsequent to being pressed down, is to increase its position by at least two millimeters towards a top surface of the physical keyboard unit and to attain said non-pressed position; wherein, when the physical button indicates the second operational mode, in which the physical keyboard unit is disabled and the screen is enabled, the laptop computer is not operationally responsive to releasing said physical keys.

In some embodiments, for example, the physical button comprises a mechanical switch able to be toggled from being at a first physical state to being at a second physical state; wherein, when the mechanical switch is in the first physical state, the physical keyboard unit is enabled and the screen unit is enabled; wherein, when the mechanical switch is in the second physical state, the physical keyboard unit is disabled and the screen unit is enabled.

In some embodiments, for example, the physical button comprises a mechanical slider able to be slid from being at a first physical position to being at a second physical position; wherein, when the mechanical slider is in the first physical position, the physical keyboard unit is enabled and the screen unit is enabled; wherein, when the mechanical slider is in the second physical position, the physical keyboard unit is disabled and the screen unit is enabled.

In some embodiments, for example, the physical button comprises a physically-pressable button able to be pressed; wherein, in response to being pressed, the physically-pressable button is to decrease its position by at least one millimeter relative to a non-pressed position of said physically-pressable button; wherein, in response to being released subsequent to being pressed, the physically-pressable button is to increase its position and return to said non-pressed position;

wherein, in response to being pressed, the physically-pressable button causes a toggle between: (a) the first mode, in which the physical keyboard unit is enabled and the screen unit is enabled, and (b) the second mode, in which the physical keyboard unit is disabled and the screen unit is enabled.

In some embodiments, for example, the laptop computer may include a processor able to execute instructions; wherein the physical button is to toggle between: (a) a first operational state of the laptop computer, in which pressing of one or more keys in the physical keyboard unit causes one or more signals to be transferred to the processor, the one or more signals indicating which one or more keys are pressed; and (b) a second operational state of the laptop computer, in which pressing of one or more keys in the physical keyboard unit causes blocking of one or more signals from being transferred to the processor, wherein the one or more signals that are blocked indicate which one or more keys are pressed.

In some embodiments, for example, the physical button comprises a dedicated button that is distinct from a group of physically-pressable keys comprising: A through Z keys, 0 through 9 keys, F1 through F12 keys, Shift key, Alt key, Ctrl key, cursor keys, and space bar.

In some embodiments, for example, the physical button comprises a dedicated button that is distinct from alphanumeric physically-pressable keys of the physical keyboard unit.

In some embodiments, for example, the physical button is located on an upward-facing panel of the physical keyboard unit.

In some embodiments, for example, the physical button is located on a vertical side panel of the physical keyboard unit.

In some embodiments, for example, in the first operational mode the physical button is to connect a link between the physical keyboard unit and a processor of the laptop computer; and in the second operational mode the physical button is to disconnect said link between the physical keyboard unit and the processor of the laptop computer.

In some embodiments, for example, the physical button is to toggle from the first operational mode to the second operational mode by disconnecting a flow of signals from the physical keyboard unit to a Central Processing Unit of the laptop computer.

In some embodiments, for example, the laptop computer comprises a device selected from the group consisting of: a netbook computer, a notebook computer.

In some embodiments, for example, the laptop computer is non-tablet, non-cellphone and non-smartphone.

In some embodiments, for example, the physical button comprises a component which is adult-deployable and is non-child-deployable.

Some embodiments may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic illustration of a laptop computer in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

The term “laptop” as used herein may include, for example, a laptop computer; a laptop device; a notebook computer; a netbook computer; a mobile computer having a first panel able to operate as a screen and a second (distinct) panel able to operate as a keyboard (and optionally have a touch-pad unit and/or other components). The screen panel and the keyboard panel may be distinct, namely, be implemented as two panels and not through a single or common panel which operates as both screen and keyboard. The “distinct” screen panel and keyboard panel may be regarded as “distinct” even though them may be interconnected through mechanical means (e.g., an axis allowing the laptop to close or open like a shell) and/or electronic means (e.g., wires, connectors and/or connections which transfer data or signals between the base panel or keyboard panel and the screen panel, and/or vice versa). The keyboard unit may thus be a physical keyboard unit non-implemented as a touch-keyboard, and not-implemented as a touch-screen keyboard.

Some embodiments may include a laptop which includes a physical switch or physical button, able to toggle the physical keyboard of the laptop between an enabled mode and a disabled mode. For example, a first deployment of the physical switch or physical button may cause the physical keyboard of the laptop to be disabled; a second deployment of the physical switch or physical button may cause the physical keyboard of the laptop to be enabled; a third deployment of the physical switch or physical button may cause the physical keyboard of the laptop to be disabled; and so forth.

Some embodiments may allow a user, for example, to launch a presentation (e.g., a PowerPoint presentation) or a slide-show or a video-clip or a movie in the laptop; and to deploy or actuate the physical switch in order to disable the physical keyboard of the laptop, until that switch is deployed again to enable the physical keyboard of the laptop. This may allow the user, as well as other viewers or an audience, to enjoy an uninterrupted presentation of content on the laptop or from the laptop (e.g., onto a larger screen or through a projector), without a concern that such presentation be accidentally interrupted if the user, or if a third party (e.g., a child of the user, or the user himself), accidentally or intentionally hits one or more physical keys of the physical keyboard of the laptop. Optionally, a touchpad of the laptop, or a mouse of the laptop, may remain enabled and operational while the physical keyboard is disabled. The screen of the laptop, as well as the processor, memory, audio speakers, microphone, and/or other components, may remain enabled and operational while the physical keyboard is disabled.

Some embodiments, for example, may allow a parent or a caregiver to utilize a laptop in order to show content (e.g., a video, a movie, an audio clip, an audio/video clip, a website, a web-page, a slide-show, an image, a text, or the like) to a child or toddler or infant or baby, which may be seated on a parent's lap or next to such laptop; and yet, may eliminate the risk or the concern in which such child, accidentally or intentionally, hits or presses or touches one or more physical keys of the physical keyboard of the laptop, thereby causing interruption in the presentation of content (e.g., stopping the presentation, pausing it, aborting it by hitting an “Escape” key, or the like). Some embodiments may thus achieve a desired balance, for example, between the need to place a child or infant or toddler or baby in relative proximity to a laptop (e.g., within one foot or two feet from the laptop's screen) so that such child may see and hear the content presented to him or her; with the need to ensure that accidental or intentional moves, or hand movements, of such child, do not interrupt or abort the presentation of content.

Some embodiments may allow a user, for example, to utilize a laptop in order to launch a process or program which may require a long time to execute (e.g., twenty minutes, one hour, three hours, or the like), including processes or programs of various types (e.g., disk defragmentation; anti-virus scanning; spyware scanning; malware scanning; disk optimization process; disk checkup process; file copying process; a program that is processing-intensive or computation-intensive); then, the user may deploy the switch in order to disable the physical keyboard of the laptop, thereby ensuring that other persons, or that the user himself, do not accidentally or intentionally interrupt or terminate such process or program, until the switch is deployed again to enable the keyboard (e.g., once the process or program ends). Optionally, some embodiments may allow the user to leave his or her laptop computer running, and executing such process or program, with reduced concern that third parties tamper with, or interrupt or abort, such process or program.

In some embodiments, the physical button may disable the physical keyboard of the laptop, while maintaining the screen and processor of the laptop enabled and operating. In some embodiments, optionally, the actuation of the physical button may also disable a touch-pad component of the laptop, together with disabling the physical keyboard of the laptop; and a subsequent actuation of the physical button may enable the touch-pad together with enabling the physical keyboard. Additionally or alternatively, in some embodiments, optionally, the actuation of the physical button may also disable a button (or multiple buttons) of touch-pad component of the laptop, together with disabling the physical keyboard of the laptop; and a subsequent actuation of the physical button may enable the previously-disabled button (or multiple buttons) of the touch-pad together with enabling the physical keyboard. Additionally or alternatively, in some embodiments, optionally, the actuation of the physical button may also disable a mouse connected to the laptop, together with disabling the physical keyboard of the laptop; and a subsequent actuation of the physical button may enable the mouse together with enabling the physical keyboard. Additionally or alternatively, in some embodiments, optionally, the actuation of the physical button may also disable all input units of the laptop except for the physical button itself, together with disabling the physical keyboard of the laptop; and a subsequent actuation of the physical button may enable the previously-disabled input units together with enabling the physical keyboard.

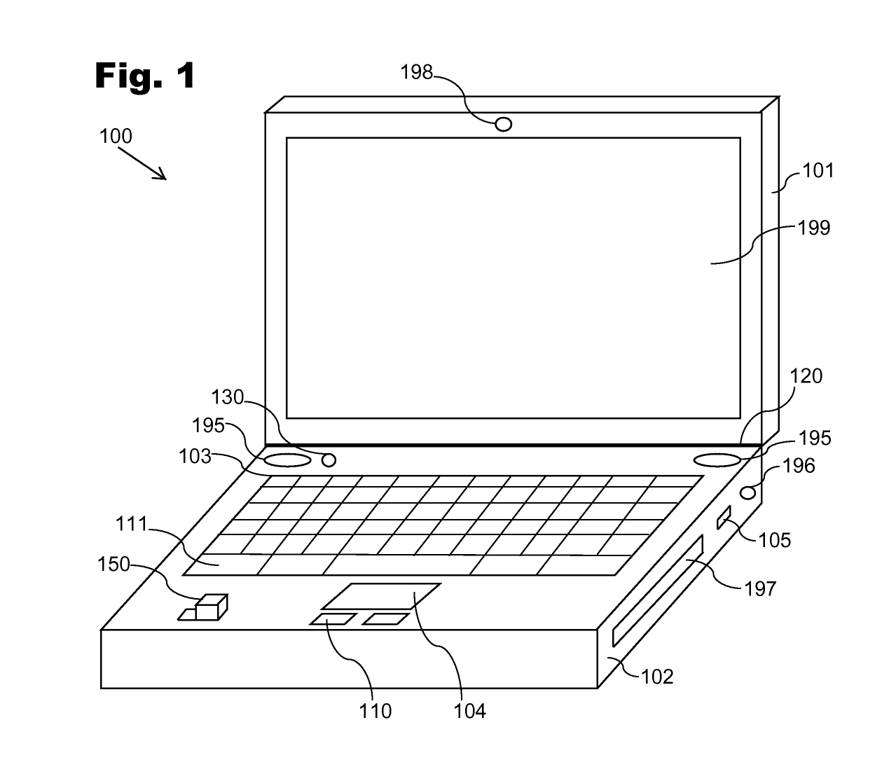

Reference is made to FIG. 1, which is a schematic illustration of a laptop 100 in accordance with some demonstrative embodiments.

Laptop 100 may be, for example, a laptop computer; a notebook computer; a netbook computer; a computer or computing device implemented by using two panels that are interconnected via an axis that allows a screen panel to rotate relative to a keyboard panel; a computer or computing device as a “shell” or a “shell”-like; or the like. In some embodiments, optionally, laptop 100 may not be a smartphone, a Personal Computer (PC), a desktop computer, a handheld device, a tablet computer, a tablet, a device in which the screen is also an input device, a device having a touch-screen, or the like.

Laptop 100 may include two panels which may be interconnected via an axis or one or more hinges. For example, a first panel be referred to herein as a base panel 101 and may include a screen 199 able to display graphics, text, and/or video. Base panel 101 may optionally include other components, for example, a camera 198 able to capture still photographs and/or video, or other optional components (e.g., a microphone able to acquire audio).

A second panel of laptop 100 may be referred to herein as a base panel 102, and may include, for example, a physical keyboard 103, a touchpad 104, one or more Universal Serial Bus (USB) ports 105, an HDMI port, a Direct Video (DV) port, a FireWire port, an eSATA port, one or more audio speakers 195, a socket for connecting headphones or earphones, a socket for connecting a microphone, or the like. Base panel 102 may include inside it, for example, a hard disk drive; a solid-state drive; Flash memory; Random Access Memory (RAM); Read Only Memory (ROM); firmware; volatile memory; non-volatile memory; or other types of storage unit(s) and/or memory unit(s). The second panel 102 may optionally include an optical or magnetic drive 197 able to read from and/or write on magnetic media and/or optical media, for example, Compact Disk (CD), Digital Versatile Disk (DVD), or the like. Base panel 102 may further include therein a Central Processing Unit (CPU), a processor, a Digital Signal Processor (DSP), a Graphics Processing Unit (GPU), an audio processing unit (“sound card”), a video processing unit (“video card”), a communication bus or communication bridge, a modem, a wireless modem, a wired modem, one or more antennas, and/or other suitable components. A storage unit or memory unit within base panel 102 may store, for example, an Operating System (OS), drivers for various internal components and/or external accessories (e.g., printer driver, scanner driver), and various software applications (e.g., word processor, spreadsheet editor, flowchart editor, games, or the like). Base panel 102 may further include an internal power source, for example, a rechargeable battery, able to provide power to one or more components of laptop 100. Base panel 102 may further include an electric socket 196 able to receive power from an external power source, in order to provide such power to components of laptop 100 and/or in order to charge the internal battery of laptop 100.

Touchpad 104 may include, for example a pointing device having a tactile sensor implemented as a touch-sensitive surface which may be capable of translating the motion and/or position of a user's finger(s) to a relative position on screen 199, and/or able to translate a user's gesture or movement of finger(s) to suitable operations (e.g., zoom in, zoom out, scroll down or up or sideways, or the like). Touchpad 104 may include, or may be in proximity to, one or more clickable or pressable buttons 110 or bar(s) which may be similar in their operation to the button(s) of a mouse input unit.

Physical keyboard 103 may include multiple physical keys 111, for example, corresponding to alpha-numeric characters of a natural language and to other suitable keys. For example, physical keyboard 103 may include a set of physical keys corresponding to: the English letters A through Z, the digits 0 through 9, punctuation characters (e.g., period, comma, semicolon), other characters (e.g., space, brackets, slash, backslash, plus sign, minus sign), as well as navigation keys (e.g., cursor keys, page up, page down, home, end) and control keys and modifier keys (e.g., ALT key, SHIFT key, CTRL key, Windows key, function keys F1 through F12, an Enter or Return key). In some embodiments, physical keyboard 103 may include at least one pair of two physical keys 111 which may be identical to each other or may perform identical function(s) (e.g., a pair of SHIFT keys, a pair of CTRL keys, a pair of ALT keys, or the like). Optionally, physical keyboard 103 may include a physical numeric keypad having the digits 0 through 9.

Each one of physical keys 111 may be physically pressable, and may change its height or location or size (e.g., by at least 1 millimeter or by at least 2 millimeters or by at least 3 millimeter, or other suitable value) upon application of pressure by a user's finger on such physical key 111. For example, each physical key 111 may include a square or rectangular surface or panel, located on top of a mechanical lever or electronic switch or spring or membrane. Each such surface or panel may have over it one or more symbols (e.g., the digit 4 and the dollar character $), which may be printed or engraved or etched on such surface or panel, or may be glued thereon.

In some embodiments, physical keyboard 103 may be manufactured as one-piece monoblock unit, positioned over one or more contact-switch membrane sheets having a space layer between. When physical pressure is applied to a physical key 111 pressing it downward, a top membrane may move downward in that particular location and may touch a bottom membrane; the particular location corresponds to a particular electrical contact being made, thereby indicating a character or symbol received as user input.

Physical keyboard 103 may include (or may be connected to, or may be associated with, or may be coupled to) keyboard-related circuitry able to convert physical presses (and/or releases) of one or more physical keys 111 into key codes or other signals that the laptop 100, through its OS and/or keyboard driver and/or processor and/or CPU, may interpret and understand and act upon and respond to. For example, in physical keyboard 103, key switches may be connected via a printed circuit board in an electrical X-Y matrix, and a voltage may be provided sequentially to the Y lines; once a key is pressed down, the voltage may be detected sequentially by scanning the X lines. Physical keyboard 103 may be associated with or connected to a power source of laptop 103, for example, an internal or external battery, a rechargeable battery, or a power supply unit (e.g., transformer) which may be connected to an external source of power (e.g., an electric power jack).

Screen 199 may be or may include, for example, LCD screen, LED screen, Organic LED (OLED) screen, plasma screen, or other suitable type of screen or monitor or display unit. In some embodiments, screen 199 may not be a touch-screen, and may not be responsive or sensitive to touching or pressing or finger(s) gestures. In other embodiments, screen 199 may be a touch-screen or a multi-touch screen, and may be responsive or sensitive to touching or pressing or finger gestures.

Screen panel 101 and base panel 102 may be interconnected via an axis 120, which may include one or more hinges and/or mechanical connectors and/or electrical connectors. Axis 120 may allow screen panel 101 to spatially rotate, or pivot, or pivotally move, or pivotally rotate, and physically close onto base panel 102, thereby physically closing laptop 100. Upon such physical closure, optionally, laptop 100 may go into a standby mode, a sleep mode, a hibernation mode, a power-saving mode, a reduced-power mode, a waiting mode, a complete shutdown, or other suitable result which may be programmed or defined by utilizing laptop 100 and its OS or software. In some embodiments, physical opening of laptop 100 may cause laptop 100 to awake from sleep mode or from hibernation mode, to go out of standby mode or reduced-power mode, to go into full power mode, to turn on, or the like.

Axis 120 may include physical connectors to connect screen panel 101 with base panel 102; as well as electrical connectors to allow, for example, exchange or transfer of information or data from base panel 102 towards screen panel 101 and/or vice versa, as well as to allow base panel 102 to provide power (e.g., from a battery or other power source of base panel 102) to screen panel 101. In some embodiments, optionally, axis 120 may allow screen panel 101 not only to close and open relative to base panel 102, but also to swivel or tilt around a central point (or near-central point) of axis 120. In some embodiments, optionally, screen panel 101 may be entirely detachable from (and re-attachable to) base panel 102, or vice versa, for example, to allow a user to replace a first screen panel with another screen panel.

Laptop 100 may include a power button 130 or other suitable power switch. In some embodiments, pressing of power button 130 may cause laptop 100 to shut down; a subsequent press of power button 130 may cause laptop 100 to turn on; and so forth. In some embodiments, a press of power button 130 may cause laptop 100 to go into sleep mode or standby mode or hibernation mode, and a subsequent press of power button 130 may cause laptop 100 to come out of sleep mode or standby mode or hibernation mode, and so forth. In some embodiments, a prolonged pressing (e.g., for five consecutive seconds) of power button 130 may cause a first result (e.g., turning on laptop 100, or turning off laptop 100); whereas a short pressing (e.g., for half a second) of power button 130 may cause a second result (e.g., toggling between standby mode and fully-operational mode).

Laptop 100 may further include a switch 150 able to toggle between (a) activation or enablement of physical keyboard 103, and (b) deactivation or disabling of physical keyboard 103, and vice versa. Switch 150 may be, for example, a physical or mechanical or electro-mechanical toggle switch which may be physically or mechanically toggled by a user (manually) from a first position or location to a second position or location, and vice versa; for example, by pushing or pulling a mechanical protrusion or lever or stick or pin, within or a long a channel or crater or recess. Alternatively, switch 150 may be, for example, a slider or a sliding switch able to slide mechanically from a first position to a second position, and vice versa. Alternatively, switch 150 may be a turn-able knob or radio-button, which may be turned clockwise or anti-clockwise between or among two or more angular positions. Alternatively, switch 150 may be a button which may be pressed down and then may remain being pressed down, until a further pressing releases the button and makes it assume (or spring back to) its previous non-pressed position. Alternatively, switch 150 may be a button similar in its physical properties to power button 130, such that, for example, a first press of switch 150 (implemented as a button) may deactivate physical keyboard 103 while switch 150 assumes its original non-pressed position; whereas a subsequent press of switch 150 may activate physical keyboard 103 while switch 150 assumes its original non-pressed position, and so forth.

Switch 150 may be located at a suitable location in laptop 100, for example: on the right side of touchpad 104, on the left side of touchpad 104, on the right side of physical keyboard 103, on the left side of physical keyboard 103, in an area of base panel 102 located between physical keyboard 103 and axis 120, in proximity to physical keyboard 103, in proximity to touchpad 104, at a vertical side of base panel 102 (e.g., near USB port 105, or near a CD drive or DVD drive of laptop 100), or the like.

In some embodiments, optionally, switch 150 may be located on screen panel 101 and not in base panel 102. In such case, wiring or circuitry may be used to allow switch 150 to function even though switch 150 is located on screen panel 101 whereas physical keyboard 103, which switch 150 is able to disable and enable, is located in base panel 102.

In some embodiments, switch 150 may be implemented as a switch or button which may be difficult to a user to push or pull or move or deploy; or, as a switch or button which may be difficult to an adult user to push or pull or move or deploy; or, as a switch or button which may be difficult to a minor user or a child user to push or pull or move or deploy; as a switch or button which may be virtually impossible for a user to push or pull or move or deploy without utilizing a tool (e.g., by necessarily utilizing a pin or a pen or a pencil to push-in or to move or to slide a small button or an internal button or a semi-internal button or a semi-hidden component or an under-the-surface element or button); or, as a switch or button which may require a user to utilize a fingernail to push or pull or move or deploy; or, as a switch or button which may be non-child-friendly, or may be child-proof; or a switch or button which is adult-depoloyable (e.g., may be readily or easily or efficiently deployed or actuated or used by an adult) and is non-child-deployable (e.g., may not be readily or easily or efficiently deployed or actuated or used by a minor or by a child); or the like. Switch 150 may be a physical component which may be distinct and separate from power button 130 and/or from any other buttons or keys of laptop 100.

Upon deployment of switch 150, switch 150 may toggle between activating and deactivating physical keyboard 103 of laptop 100 (or, may toggle or switch among three or more modes, two of such modes are a physical keyboard enabled mode and a physical keyboard disabled mode), without interrupting or affecting other functionality of laptop 100 or its OS or its software programs, and without causing laptop 100 to go into standby mode or sleep mode or hibernation mode or reduced-power mode, and without causing laptop 100 to turn off completely or partially.

In some embodiments, when switch 150 is in a “physical keyboard enabled” position or mode, then, switch 150 may physically connect as a component within an electric circuit which provides power to physical keyboard 103. Whereas, when switch 150 is in a “physical keyboard disabled” position or mode, then, switch 150 may physically disconnect or break an electric circuit which provides power to physical keyboard 103.

In some embodiments, when switch 150 is in a “physical keyboard enabled” position or mode, then, switch 150 may physically connect as a component within an electric circuit which provides power to a keyboard controller (e.g., a hardware-based keyboard controller) which controls physical keyboard 103. Whereas, when switch 150 is in a “physical keyboard disabled” position or mode, then, switch 150 may physically disconnect or break an electric circuit which provides power to a keyboard controller (e.g., a hardware-based keyboard controller) which controls physical keyboard 103.

In some embodiments, when switch 150 is in a “physical keyboard enabled” position or mode, then, switch 150 may physically enable transfer of signals and/or data, over a wired connection or link or circuit, in the direction going from physical keyboard 103 towards the keyboard controller (e.g., a hardware-based keyboard controller) which controls physical keyboard 103; or from such keyboard controller towards other components of laptop 100 (e.g., the CPU of laptop 100, the OS of laptop 100, or a keyboard driver software component of laptop 100). Whereas, when switch 150 is in a “physical keyboard disabled” position or mode, then, switch 150 may physically disable or stop or break or block transfer of signals and/or data, over a wired connection or link or circuit, in the direction going from physical keyboard 103 towards the keyboard controller (e.g., a hardware-based keyboard controller) which controls the physical keyboard 103; or from such keyboard controller towards other components of laptop 100 (e.g., the CPU of laptop 100, the OS of laptop 100, or a keyboard driver software component of laptop 100).

In some embodiments, when switch 150 is in a “physical keyboard disabled” position or mode, then, switch 150 may disable or turn-off or suspend or deactivate or break an electric circuit or a communication circuit of, for example, one or more software component and/or hardware components, of physical keyboard 103 and/or of laptop 100; which are associated, for example, with the proper operation of the physical keyboard 103, and/or with transfer of signals or data from physical keyboard 103 to other component(s) of laptop 100, and/or with providing power or voltage or current to physical keyboard 103 or to other components associated with physical keyboard 103. Whereas, when switch 150 is in a “physical keyboard enabled” position or mode, then, switch 150 may enable or turn-on or activate or complete or connect an electric circuit or a communication circuit of, for example, one or more software components and/or hardware components, of physical keyboard 103 and/or of laptop 100; which are associated, for example, with the proper operation of physical keyboard 103, and/or with transfer of signals or data from physical keyboard 103 to other component of laptop(a) 100, and/or with providing power or voltage or current to physical keyboard 103 or to other components associated with physical keyboard 103.

In some embodiments, switch 150 may be implemented as multiple physical or mechanical switches which may have a logical OR relation among them (e.g., such that deactivation of one of such switches may suffice in order to deactivate or disable physical keyboard 103); or as multiple physical or mechanical switches which may have a logical AND relation among them (e.g., such that deactivation of all of such switches may be required in order to deactivate or disable physical keyboard 103); or as multiple physical or mechanical switches which may have other types of logical relation among them (e.g., such that each one of the multiple switches may activate and deactivate physical keyboard 103 upon toggling of such switch, independently of the position or mode of the other switch(es) in laptop 100).

In some embodiments, optionally, switch 150 may be implemented as a unified physical switch which may be able to activate or deactivate, both physical keyboard 103 and touchpad 104 at the same time or substantially at the same time. For example, deployment of switch 150 may concurrently enable, or may concurrently disable, both physical keyboard 103 and touchpad 104; or may otherwise concurrently toggle among activation and deactivation of these two input units of laptop 100. For example, when switch 150 is in a position or mode of “physical keyboard and touchpad disabled”, then, switch 150 may deactivate or disable one or more software and/or hardware components (e.g., controllers, drivers, or the like), or may break or disconnect one or more electric circuits or communication links, which may be associated with the proper operation of physical keyboard 103 and touchpad 104, or may break or disconnect one or more links or circuits which transfer data or signals from physical keyboard 103 and/or from touchpad 104 to the CPU or OS of laptop 100. Whereas, when switch 150 is in a position or mode of “physical keyboard and touchpad disabled”, then, switch 150 may activate or enable one or more software and/or hardware components (e.g., controllers, drivers, or the like), or may connect one or more electric circuits or communication links, which may be associated with the proper operation of physical keyboard 103 and touchpad 104, or may connect or complete one or more links or circuits which transfer data or signals from physical keyboard 103 and/or from touchpad 104 to the CPU or OS of laptop 100. Optionally, switch 150 may similarly control, toggle, deactivate and/or activate a set of input units together, for example, physical keyboard 103, touchpad 104, a corded or wireless mouse input device which may be connected to laptop 100, or the like.

In some embodiments, deployment or actuation of switch 150 into a position or mode of “physical keyboard disabled”, may operate to block or eliminate, for example: (a) substantially all signals or data or commands going from physical keyboard 103 to a keyboard controller or a communication bus associated with physical keyboard 103; and/or (b) substantially all signals or data or commands going from physical keyboard 103 to other components associated with physical keyboard 103; and/or (c) substantially all signals or data or commands going from physical keyboard 103 to an OS of laptop 100; and/or (d) substantially all signals or data or commands going from physical keyboard 103 to a keyboard driver of laptop 100; and/or (e) the providing or the flow, of power or current or voltage, to physical keyboard 103; and/or (f) the providing or the flow, of power or current or voltage, to a hardware-based keyboard controller associated with physical keyboard 103; and/or (g) other components or links or connections which may be required for full and proper operation of physical keyboard 103. Whereas, deployment or actuation of switch 150 into a position or mode of “physical keyboard enabled” may perform contrarian operation(s) to achieve the opposite result, in which signals or data or commands from physical keyboard 103 properly reach the OS or CPU of laptop 100 and/or are properly processed (or acted upon) by the OS or CPU of laptop 100.

In some embodiments, deployment or actuation of switch 150 into a position or mode of “physical keyboard disabled”, may be translated into (or interpreted as) a command directed to the OS or the CPU or the keyboard driver or the keyboard controller of laptop 100, commanding one or more of these components to ignore (or not store, or not process, or not act upon, or discard) substantially all signals or data or commands incoming from physical keyboard 103; until a contrarian command is transferred via switch 150 upon its deployment or actuation into a position or mode of “physical keyboard enabled”.

In some embodiments, switch 150 may be operational to toggle between disabling and enabling physical keyboard 103 as a stand-alone mechanical switch or button, or in a single-step process, or in a process which does not require any user-initiated modifications of settings in a “control panel” or in “settings” or “definitions” of an Operating System of laptop 100 or of a software component thereof; and may not require the user to use a mouse, or touchpad 104, or physical keyboard 103 itself, in order to enable and/or disable physical keyboard 103; and may not require the user to navigate through one or more menus or options or windows, or to open windows or to open applications, or to select or unselect boxes or options or check-boxes or radio-buttons or drop-down menus or other interface elements. Some embodiments may thus provide a one-click or one-movement operation to substantially immediately toggle between enablement and disablement of physical keyboard 103 of laptop 100.

In some embodiments, optionally, the operation or functionality of switch 150 may be part of a multi-step process, which may, for example, further require the user to enter a pre-defined password or Personal Identification Number (PIN) in order to allow such toggling to take effect. For example, physical deployment of switch 150, from a keyboard-enabled mode to a keyboard-disabled mode, and/or vice versa, may require the user to enter a pre-defined or user-defined password or PIN. In some embodiments deployment of switch 150 from a keyboard-enabled mode to a keyboard-disabled mode may trigger a process in which the laptop asks the user to select a password, which the laptop computer may store, and that the user may later be required to enter upon attempting to toggle back the laptop from a keyboard-disabled mode to a keyboard-enabled mode. In some embodiments, the password required to confirm or authorize the toggling may be the OS password, a boot-process password, a BIOS password, a user log-in password, an Administrator password, a dedicated password used uniquely or distinctly in conjunction with the toggling of the physical keyboard, or other type of user-defined or user-modifiable password.

In some embodiments, switch 150 may auto-deploy itself (e.g., particularly if switch 150 is implemented as a mechanically-pressable button which may be similar in its mechanical properties to a power button of a laptop computer), if laptop 100 auto-detects that one or more pre-defined and/or user-modifiable conditions hold true. For example, switch 150 may be implemented as a physical button which may be similar to a power button of a conventional laptop, such that the physical button (switch 150) may be physically pressed down approximately 1 or 2 or 3 millimeters, and when released it may rise back to its non-pressed position. Such switch 150 may self-deploy or self-actuate (e.g., may function as if it was pressed and released, without actually decreasing and increasing in height), for example, may automatically and autonomously and independently toggle from a keyboard-enabled mode to a keyboard-disabled mode, if one or more of the following conditions holds true: (a) laptop 100 is utilized to view or open or play or launch a presentation (e.g., PowerPoint presentation or PPT file or PPS file), a video file (e.g., AVI file, DIVX file, MP4 file, MOV file, QuickTime file, WMV file, FLV file), an audio file (e.g., MP3 file, Ogg Vorbis file, WMA file, WAV file), a streaming video (e.g., on YouTube, on Amazon), a streaming audio (e.g., on YouTube, on Amazon), a DVD disk, a Compact Disk, or other multimedia presentation or audio/video clip or file or segment; (b) a pre-defined or user-defined or user-modifiable time-period (e.g., 20 seconds or one minute) elapsed since physical keyboard 103 was last used or pressed; (c) both of the above conditions (a) and (b) cumulatively hold true; (d) the user (via laptop 100) is viewing an item or an application or a file or an audio/video clip by using Full Screen View, such as, by instructing a software application (e.g., Microsoft Word, or Adobe Acrobat Reader, or Windows Media Player, or an Internet browser) to show or display or present content by utilizing the entire screen and while hiding menu(s) and/or buttons and/or a seek bar and/or other user-interface components; (e) other suitable conditions, or a combination of multiple conditions, hold true. In some embodiments, laptop 100 may include hardware logic and/or circuitry and/or software (e.g., driver, or OS component, or an application) able to automatically monitor and sense or detect whether the pre-defined conditions hold true (e.g., able to monitor and detect that the user or laptop 100 have initiated playback of a video, a presentation, a DVD or a CD), and may thus automatically initiate the toggling from the keyboard-enabled mode to the keyboard-disabled mode. In some embodiments, toggling-back from keyboard-disabled mode to keyboard-enabled mode may be allowed and/or performed only by the user pressing (or otherwise deploying or actuating) physical switch 150, and not via physical keyboard 103 which has been automatically disabled.

Switch 150 may be connected and/or operative at one or more suitable locations along the route in which data, signals and/or commands flow from keys of physical keyboard 103 and onward. For example, switch 150 may be connected, or may be operative, between membranes which lie underneath or within physical keyboard 103; between such membranes and a voltage or current provider to such membranes; between such membranes and a voltage scanner or a matrix scanner or a row scanner which captures key-presses; between such scanner and a keyboard controller, or keyboard control circuitry, or keyboard interpretation circuitry, which is operative to capture key-presses and translate them into signals or commands or data corresponding to (or indicating) the pressed physical key(s); between such keyboard control circuitry (or keyboard interpretation circuitry) and a communication bus or communication link of laptop 100 which collects or receives or transfers signals or data received from one or more input units; between such keyboard control circuitry (or keyboard interpretation circuitry) or a communication bus or communication link, and a processor or CPU or other controller of laptop 100 which is generally operative to receive signals, data and/or commands that originate in key-press(es) and to act upon them, or to process them, or to store them, or to command other components of laptop 100 to act upon them, or to transfer them to other components of laptop 100; between a processor or CPU or controller of laptop 100, and a storage unit or memory unit or buffer utilized for storing data corresponding to incoming key-presses; or at other suitable location(s) within laptop 100.

Although portions of the discussion herein relate, for demonstrative purposes, to wired links and/or wired communications, some embodiments are not limited in this regard, and may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device (e.g., a device incorporating functionalities of multiple types of devices, for example, PDA functionality and cellular phone functionality), a vehicular device, a non-vehicular device, a mobile or portable device, a non-mobile or non-portable device, a wireless communication station, a wireless communication device, a wireless Access Point (AP), a wireless Base Station (BS), a Mobile Subscriber Station (MSS), a wired or wireless Network Interface Card (NIC), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating in accordance with existing IEEE 802.11, 802.11a, 802.11b, 802.11g, 802.11n, 802.16, 802.16d, 802.16e, 802.16m standards and/or future versions and/or derivatives of the above standards, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or tag or transponder, a device which utilizes Near-Field Communication (NFC), a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, a “smart-phone” device, an iPhone or a similar device, an iPod or iPod Touch or iPad or iPad-2 or Motorola Xoom or similar device, a wired or wireless handheld device (e.g., BlackBerry Curve or Torch, or HTC Incredible, or Samsung Galaxy Tab), a Wireless Application Protocol (WAP) device, a hybrid device (e.g., combining one or more cellular phone functionalities with one or more PDA device functionalities), a portable audio player, a portable video player, a portable audio/video player, a portable media player, a gaming device, a portable or non-portable gaming console, a portable device having a touch-screen, a relatively small computing device, a non-desktop computer or computing device, a portable device, a handheld device, a “Carry Small Live Large” (CSLL) device, an Ultra Mobile Device (UMD), an Ultra Mobile PC (UMPC), a Mobile Internet Device (MID), a Consumer Electronic (CE) device, an “Origami” device or computing device, a device that supports Dynamically Composable Computing (DCC), a context-aware device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), OFDM Access (OFDMA), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth (RTM), Global Positioning System (GPS), IEEE 802.11 (“Wi-Fi”), IEEE 802.16 (“Wi-Max”), ZigBee™, Ultra-Wideband (UWB), Global System for Mobile communication (GSM), 2G, 2.5G, 3G, Third Generation Partnership Project (3GPP), 3GPP Long Term Evolution (LTE), 3.5G, or the like. Some embodiments may be used in conjunction with various other devices, systems and/or networks.

The terms “wireless device”, “wireless computing device”, “mobile device” or “mobile computing device” as used herein include, for example, a portable or mobile device capable of wireless communication, a portable or mobile communication device capable of wireless communication, a mobile phone, a cellular phone, a laptop or notebook computer capable of wireless communication, a PDA capable of wireless communication, a handheld device capable of wireless communication, or the like.

The terms “web” or “Web” as used herein includes, for example, the World Wide Web; a global communication system of interlinked and/or hypertext documents, files, web-sites and/or web-pages accessible through the Internet or through a global or regional or national communication network; including text, images, videos, multimedia components, hyperlinks, and/or other content which may be available online.

The term “user” as used herein includes, for example, a person or entity that owns a laptop computer; a person or entity that operates or utilizes a laptop computer; or a person or entity that is otherwise associated with a laptop computer.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” or “a plurality” as used herein include, for example, “multiple” or “two or more”. For example, “a plurality of items” includes two or more items.

Some embodiments may take the form of an entirely hardware embodiment, an entirely software embodiment, or an embodiment including both hardware and software elements. Some embodiments may be implemented by utilizing firmware, resident software, microcode, or the like.

Some embodiments may take the form of (or may utilize) a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be or may include an electronic, magnetic, optical, electromagnetic, InfraRed (IR), or semiconductor system (or apparatus or device) or a propagation medium. Some demonstrative examples of a computer-readable medium may include a semiconductor or solid state memory, magnetic tape, a removable computer diskette, a Random Access Memory (RAM), a Read-Only Memory (ROM), a rigid magnetic disk, an optical disk, or the like. Some demonstrative examples of optical disks include Compact Disk-Read-Only Memory (CD-ROM), Compact Disk-Read/Write (CD-R/W), DVD, or the like.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (e.g., keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Some embodiments may be implemented by software, by hardware, or by any combination of software and/or hardware as may be suitable for specific applications or in accordance with specific design requirements. Some embodiments may include units and/or sub-units, which may be separate of each other or combined together, in whole or in part, and may be implemented using specific, multi-purpose or general processors or controllers. Some embodiments may include buffers, registers, stacks, storage units and/or memory units, for temporary or long-term storage of data or in order to facilitate the operation of particular implementations.

Some embodiments may be implemented, for example, using a machine-readable medium or article which may store an instruction or a set of instructions that, if executed by a machine, cause the machine to perform a method and/or operations described herein. Such machine may include, for example, any suitable processing platform, computing platform, computing device, processing device, electronic device, electronic system, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, JavaScript, BASIC, Pascal, Fortran, Cobol, assembly language, machine code, machine language, or the like.

Functions, operations, components and/or features described herein with reference to one or more embodiments, may be combined with, or may be utilized in combination with, one or more other functions, operations, components and/or features described herein with reference to one or more other embodiments, or vice versa.

While certain features of some embodiments have been illustrated and described herein, many modifications, substitutions, changes, and equivalents may occur to those skilled in the art. Accordingly, the following claims are intended to cover all such modifications, substitutions, changes, and equivalents.

What is claimed is:

1. A laptop computer comprising:
a screen unit to display text and graphics;
a physical keyboard unit comprising a plurality of physically-pressable keys to receive user keypresses, wherein the physical keyboard unit and the screen units are two distinct hardware units; and
a physical button to toggle between a first operational mode and a second operational mode,
wherein in the first operational mode the physical keyboard unit is enabled and the screen unit is enabled, and in the second operational mode the physical keyboard unit is disabled and the screen is enabled.

2. The laptop computer of claim 1, wherein the physical keyboard unit is part of a base unit of the laptop, and wherein the base unit is mechanically connected to the screen unit via one or more hinges.

3. The laptop computer of claim 1, wherein the screen unit is able to rotate via a single angle of rotation relative to the physical keyboard unit.

4. The laptop computer of claim 1, wherein the screen unit and the physical keyboard unit comprise two respective and interconnected parts of a shell-like laptop structure.

5. The laptop computer of claim 1, wherein the physical keyboard unit comprises a plurality of physical keys; wherein each one of the physical keys, upon being pressed down, is to decrease its position by at least two millimeters below a non-pressed position;
wherein, when the physical button indicates the second operational mode, in which the physical keyboard unit is disabled and the screen is enabled, the laptop computer is not operationally responsive to pressing down of said physical keys.

6. The laptop computer of claim 5, wherein each one of said physical keys, upon being released subsequent to being pressed down, is to increase its position by at least two millimeters towards a top surface of the physical keyboard unit and to attain said non-pressed position;
wherein, when the physical button indicates the second operational mode, in which the physical keyboard unit is disabled and the screen is enabled, the laptop computer is not operationally responsive to releasing said physical keys.

7. The laptop computer of claim 1, wherein the physical button comprises a mechanical switch able to be toggled from being at a first physical state to being at a second physical state;
wherein, when the mechanical switch is in the first physical state, the physical keyboard unit is enabled and the screen unit is enabled;
wherein, when the mechanical switch is in the second physical state, the physical keyboard unit is disabled and the screen unit is enabled.

8. The laptop computer of claim 1, wherein the physical button comprises a mechanical slider able to be slid from being at a first physical position to being at a second physical position;
wherein, when the mechanical slider is in the first physical position, the physical keyboard unit is enabled and the screen unit is enabled;
wherein, when the mechanical slider is in the second physical position, the physical keyboard unit is disabled and the screen unit is enabled.

9. The laptop computer of claim 1, wherein the physical button comprises a physically-pressable button able to be pressed;
wherein, in response to being pressed, the physically-pressable button is to decrease its position by at least one millimeter relative to a non-pressed position of said physically-pressable button;
wherein, in response to being released subsequent to being pressed, the physically-pressable button is to increase its position and return to said non-pressed position;
wherein, in response to being pressed, the physically-pressable button causes a toggle between: (a) the first mode, in which the physical keyboard unit is enabled and the screen unit is enabled, and (b) the second mode, in which the physical keyboard unit is disabled and the screen unit is enabled.

10. The laptop computer of claim 1, comprising a processor able to execute instructions;
wherein the physical button is to toggle between:
(a) a first operational state of the laptop computer, in which pressing of one or more keys in the physical keyboard unit causes one or more signals to be transferred to the processor, the one or more signals indicating which one or more keys are pressed;
and
(b) a second operational state of the laptop computer, in which pressing of one or more keys in the physical keyboard unit causes blocking of one or more signals from being transferred to the processor, wherein the one or more signals that are blocked indicate which one or more keys are pressed.

11. The laptop computer of claim 1, wherein the physical button comprises a dedicated button that is distinct from a group of physically-pressable keys comprising: A through Z keys, 0 through 9 keys, F1 through F12 keys, Shift key, Alt key, Ctrl key, cursor keys, and space bar.

12. The laptop computer of claim 1, wherein the physical button comprises a dedicated button that is distinct from alphanumeric physically-pressable keys of the physical keyboard unit.

13. The laptop computer of claim 1, wherein the physical button is located on an upward-facing panel of the physical keyboard unit.

14. The laptop computer of claim 1, wherein the physical button is located on a vertical side panel of the physical keyboard unit.

15. The laptop computer of claim 1, wherein in the first operational mode the physical button is to connect a link between the physical keyboard unit and a processor of the laptop computer; and wherein in the second operational mode the physical button is to disconnect said link between the physical keyboard unit and the processor of the laptop computer,

16. The laptop computer of claim 1, wherein the physical button is to toggle from the first operational mode to the second operational mode by disconnecting a flow of signals from the physical keyboard unit to a Central Processing Unit of the laptop computer.

17. The laptop computer of claim 1, wherein the laptop computer comprises a device selected from the group consisting of: a netbook computer, a notebook computer.

18. The laptop computer of claim 1, wherein the laptop computer is non-tablet, non-cellphone and non-smartphone.

19. The laptop computer of claim 1, wherein the physical button comprises a component which is adult-deployable and is non-child-deployable.
